(19) United States
(12) Patent Application Publication
(10) Pub. No.: US 2010/0131184 A1
(43) Pub. Date: May 27, 2010

(54) Method for creating suggested pathways for helping pedestrians cross open spaces

(76) Inventor: Richard Stanton, Auckland (NZ)

Correspondence Address: NORTH AMERICA INTELLECTUAL PROPERTY CORPORATION, P.O. BOX 506, MERRIFIELD, VA, 22116, US

(21) Appl. No.: 12/275,225

(22) Filed: Nov. 21, 2008

(51) Int. Cl. G01C 21/36

(52) U.S. Cl. 701/200

(57) ABSTRACT

A method of creating suggested pathways across a predefined area for guiding pedestrians across the predefined area is disclosed. The method includes loading a polygon representation of the predefined area, the polygon comprising at least four vertices, and connecting pairs of non-adjacent vertices of the polygon to create the suggested pathways. Alternatively, the method can generate a polygon representation of the predefined area, identify all nodes on a border of the polygon, the nodes being formed by the intersection of two roads on or adjacent to the border of the polygon, and connect pairs of nodes to create the suggested pathways.

### BACKGROUND OF THE INVENTION

1. Field of the Invention

The invention relates to a method for guiding pedestrians through open spaces with a personal navigation device, and more particularly, to a method for creating suggested pathways through the open spaces for guiding pedestrians through the open spaces.

2. Description of the Prior Art

Global Positioning System (GPS) based navigation devices are well known and are widely employed as in-car navigation devices. Common functions of a navigation device include providing a map database for generating navigation instructions that are then shown on a display of the navigation device. These navigation devices are often mounted on or in the dashboard of a vehicle using a suction mount or other mounting means.

The term “navigation device” refers to a device that enables a user to navigate to a pre-defined destination. The device may have an internal system for receiving location data, such as a GPS receiver, or may merely be connectable to a receiver that can receive location data. The device may compute a route itself, or communicate with a remote server that computes the route and provides navigation information to the device, or a hybrid device in which the device itself and a remote server both play a role in the route computation process. Personal GPS navigation devices are not permanently integrated into a vehicle but instead are devices that can readily be mounted in or otherwise used inside a vehicle. Generally (but not necessarily), they are fully self-contained—i.e. include an internal GPS antenna, navigation software and maps and can hence plot and display a route to be taken.

In addition to being used in a vehicle, the personal navigation devices can also be taken out of the vehicle and carried on foot for helping pedestrians find their way. Unlike vehicles, pedestrians are not limited to traveling only on a network of roads. Instead, pedestrians can cut across open spaces in order to reach their destination faster or to simply have a more enjoyable route away from traffic. However, at the present, personal navigation devices do not indicate suggested pathways for users to take across the open spaces.

Please refer to FIG. 1. FIG. 1 is a diagram showing possible paths around a park 30 according to the prior art. FIG. 1 shows the park 30 surrounded by a plurality of roads 32, 34, 36, 38, and 40. For convenience in explaining the diagram, reference points P10-P14 are marked on FIG. 1. Point P10 is located where road 32 and road 34 meet, point P11 is located where road 34 and road 36 meet, point P12 is located where road 36 and road 38 meet, point P13 is located where road 38 and road 40 meet, and point P14 is located where road 40 and road 32 meet.

Still referring to FIG. 1, suppose that a user of a personal navigation device wishes to travel from point P10 to point P13. Since the personal navigation device only generates route information based on the road network, the personal navigation device would likely instruct the user to follow road 32 from point P10 to point P14, and then to follow road 40 from point P14 to point P13. Therefore, even though a shortcut could be taken across the park 30 to go on a more direct path from point P10 to point P13, the personal navigation device does not indicate this fact to the user.

Please refer to FIG. 2. FIG. 2 is a diagram showing possible paths around a park 10 according to the prior art. FIG. 2 shows roads 12, 14, and 16 bordering the park 10. Point P1 is located at a top-left corner of the park 10, which is also where the roads 12 and 16 intersect, and point P2 is located at a top-right corner of the park 10, which is where the roads 14 and 16 intersect. Point P3 is located at a bottom-left corner of the park along road 12, and point P4 is located at a bottom-right corner of the park along road 14.

Still referring to FIG. 2, suppose a user wishes to travel from point P1 to point P4. Since the personal navigation device only generates route information based on the road network, the personal navigation device would likely instruct the user to follow road 16 from point P1 to point P2, and then to follow road 14 from point P2 to point P4. Thus, even though a shortcut could be taken across the park 10 to go on a more direct path from point P1 to point P4, the personal navigation device does not indicate this fact to the user.

Please refer to FIG. 3. FIG. 3 is a diagram showing possible paths around a park 50 according to the prior art. FIG. 3 shows roads 56, 60, and 62 bordering the park 50, along with roads 52, 54, and 58 that lead up to and terminate at the park. Points P30, P31, and P32 are formed at the points where road 60 intersects roads 52, 54, and 56, respectively. Similarly, points P33 and P34 are formed at the points where road 62 intersects roads 56 and 58, respectively.

Still referring to FIG. 3, suppose a user wishes to travel from point P30 to point P34. Since the personal navigation device only generates route information based on the road network, the personal navigation device would likely instruct the user to follow road 60 from point P30 to point P35, to follow road 64 from point P35 to point P36, and then to follow road 62 from point P36 to P34. Therefore, the user is not instructed to cut across the park 50, and is in fact told to go away from the park in order to find the nearest road that can take the user from road 60 to road 62. Due to these limitations, there is clearly room for improvement in the way that personal navigation devices generate path information for crossing large open spaces such as parks.

### SUMMARY OF THE INVENTION

It is therefore one of the primary objectives of the claimed invention to provide methods of creating suggested pathways across open spaces such as parks or other predefined areas in order to guide pedestrians across the open spaces or predefined areas.

According to an exemplary embodiment of the claimed invention, a method of creating suggested pathways across a predefined area for guiding pedestrians across the predefined area is disclosed. The method includes loading a polygon representation of the predefined area, the polygon comprising at least four vertices, and connecting pairs of non-adjacent vertices of the polygon to create the suggested pathways.

According to another exemplary embodiment of the claimed invention, a method of creating suggested pathways across a predefined area for guiding pedestrians across the predefined area is disclosed. The method includes loading a polygon representation of the predefined area, identifying all nodes on a border of the polygon, the nodes being formed by the intersection of two roads on or adjacent to the border of the polygon, and connecting pairs of nodes to create the suggested pathways.

According to yet another exemplary embodiment of the claimed invention, a method of creating suggested pathways across a predefined area for guiding pedestrians across the predefined area is disclosed. The method includes loading a polygon representation of the predefined area, the polygon comprising at least four vertices, connecting pairs of non-adjacent vertices of the polygon to create suggested pathways, identifying all nodes on a border of the polygon, the nodes being formed by the intersection of two roads on or adjacent to the border of the polygon, and connecting pairs of nodes to create suggested pathways.

It is an advantage that the method suggests pathways across the predefined area instead of forcing pedestrians to go around the predefined area on a road network. In this way, pedestrians can cut across open spaces in order to reach their destination faster, and can also have a more enjoyable route for walking away from traffic.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3 are diagrams showing possible paths around parks according to the prior art.

FIGS. 4-5 are diagrams showing possible paths around a park as well as suggested paths through the park according to a first embodiment of the present invention.

FIG. 6 is a diagram showing possible paths around a park as well as suggested paths through the park according to a second embodiment of the present invention.

FIG. 7 is a diagram showing possible paths around the park as well as suggested paths through the park according to a third embodiment of the present invention.

### DETAILED DESCRIPTION

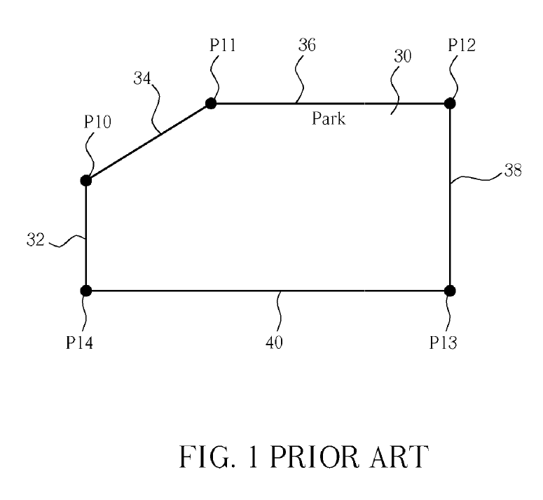

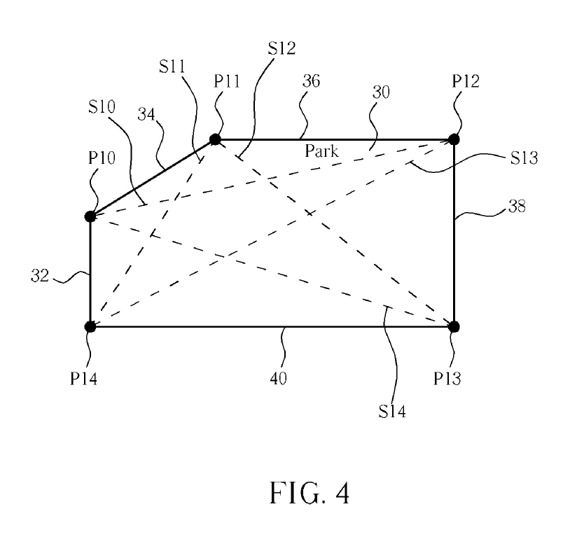

Please refer to FIG. 4. FIG. 4 is a diagram showing possible paths around the park 30 as well as suggested paths through the park 30 according to a first embodiment of the present invention. Differing from the diagram shown in FIG. 1, FIG. 4 shows suggested paths S10-S14 that pass through the park 30. In order to determine the locations of the suggested paths, the first embodiment of the present invention represents the park 30 in the shape of a polygon. In this case, the park 30 has five sides, and therefore has the shape of an irregular pentagon. In the first embodiment of the present invention, the vertices of the polygon, shown at points P10-P14 are then selected as the possible points from which the suggested paths begin and end. The suggested paths S10-S14 are formed as straight line segments between all non-adjacent nodes of the polygon. If there happen to be any suggested paths that lie along existing road segments of a road network, these suggested paths are removed since they are redundant. The result of this is that the suggested paths S10-S14 all pass through the polygon. Therefore, as shown in FIG. 4, the suggested paths S10-S14 are all shortcuts that can be taken across the park 30 from one corner of the park 30 to another.

Revisiting the first example mentioned previously, suppose that a user of a personal navigation device wishes to travel from point P10 to point P13. Instead of instructing the user of the personal navigation device to follow road 32 from point P10 to point P14, and then to follow road 40 from point P14 to point P13, a more direct route is suggested. The personal navigation device utilizing the first embodiment method of the present invention would instead instruct the user to follow the suggested path S14, which takes the user directly from point P10 to point P13.

In order to ensure that the generated suggested paths are as useful as possible, the vertices of the polygons can be snapped up to the road network to allow the user to transit from the road network to the suggested paths as quickly and easily as possible.

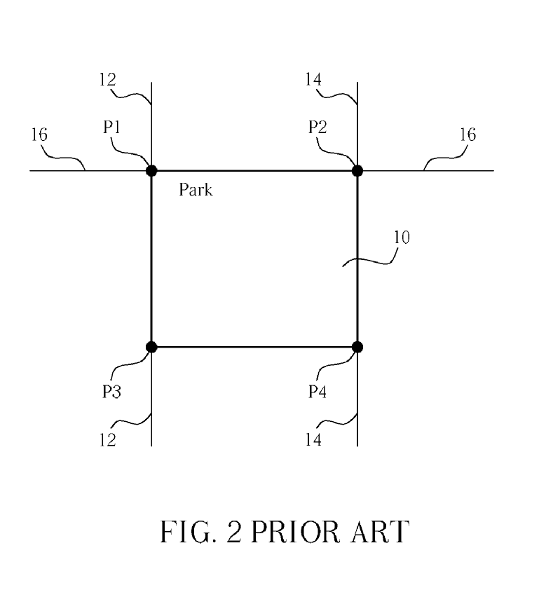

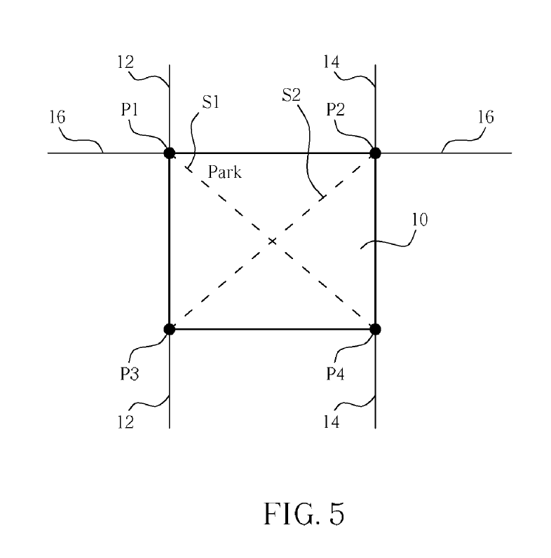

Please refer to FIG. 5. FIG. 5 is a diagram showing possible paths around the park 10 as well as suggested paths through the park 10 according to the first embodiment of the present invention. Differing from the diagram shown in FIG. 2, FIG. 5 shows suggested paths S1 and S2 that pass through the park 10. The suggested paths S1 and S2 are formed between all non-adjacent sides of the polygon formed by vertices P1-P4.

Revisiting the second example mentioned previously, suppose that a user of a personal navigation device wishes to travel from point P1 to point P4. Instead of instructing the user to follow road 16 from point P1 to point P2, and then to follow road 14 from point P2 to point P4, a more direct route is suggested. The personal navigation device utilizing the first embodiment method of the present invention would instead instruct the user to follow the suggested path S1, which takes the user directly from point P1 to point P4.

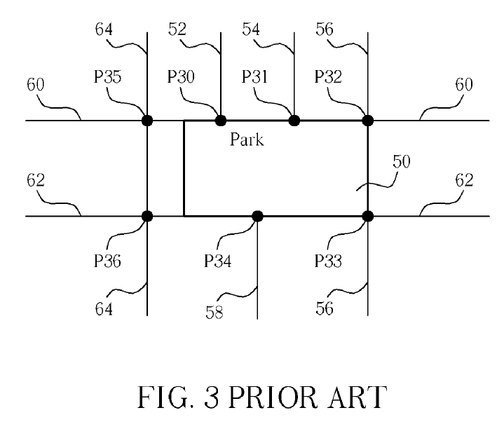

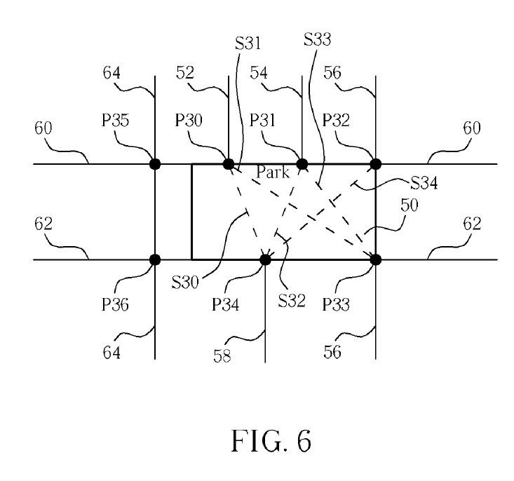

Please refer to FIG. 6. FIG. 6 is a diagram showing possible paths around the park 50 as well as suggested paths through the park 50 according to a second embodiment of the present invention. Differing from the diagram shown in FIG. 3, FIG. 6 shows suggested paths S30-S34 that pass through the park 50. In order to determine the locations of the suggested paths, the second embodiment of the present invention represents the park 50 in the shape of a polygon. Then all of the nodes along the border of the polygon are identified. In this context, a node is formed by the intersection of two roads on or adjacent to the border of the polygon. In FIG. 6, points P30-P34 are all nodes along the border of the park 50. Once all of the nodes have been identified, pairs of nodes are connected in order to create the suggested paths S30-S34. The suggested paths S30-S34 are preferably formed as straight line segments between the nodes.

As with the first embodiment, if there happen to be any suggested paths that lie along existing road segments of a road network, these suggested paths are removed in the second embodiment method since they are redundant. The result of this is that the suggested paths S30-S34 all pass through the polygon. Therefore, as shown in FIG. 6, the suggested paths S30-S34 are all shortcuts that can be taken across the park 50 from one node along the border of the park 50 to another.

Revisiting the last example mentioned previously, suppose that a user of a personal navigation device wishes to travel from point P30 to point P34. Instead of instructing the user to follow road 60 from point P30 to point P35, to follow road 64 from point P35 to point P36, and then to follow road 62 from point P36 to P34, a more direct route is suggested. The personal navigation device utilizing the second embodiment method of the present invention would instead instruct the user to follow the suggested path S30, which takes the user directly from point P30 to point P34.

Instead of selecting either of the first or second embodiment methods independently, both of the first and second embodiment methods can be utilized at the same time for creating even more suggested paths. In other words, the suggested paths can be created by connecting non-adjacent vertices of a polygon as well as by connecting nodes located on or adjacent to the border of the polygon.

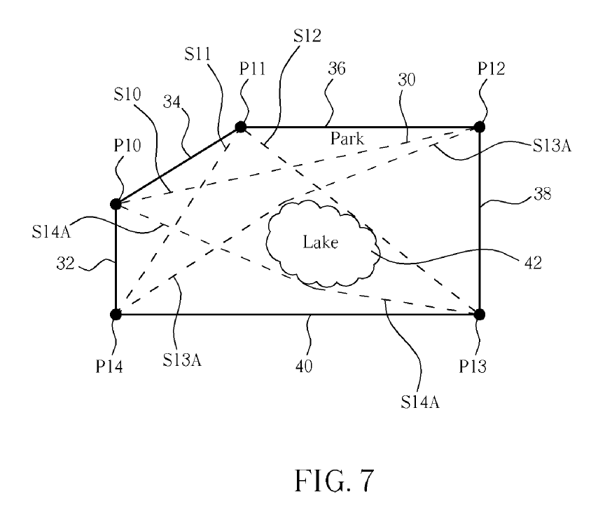

Please refer to FIG. 7. FIG. 7 is a diagram showing possible paths around the park 30 as well as suggested paths through the park 30 according to a third embodiment of the present invention. Differing from the diagram shown in FIG. 4, FIG. 7 shows the park 30 containing a lake 42. The lake 42 is a barrier that blocks suggested paths that would otherwise be suggested by the personal navigation device. Other examples of barriers include streams, rivers, or off-limits areas. Due to the lake, the suggested paths S13A and S14A are bent, and are formed by connecting two line segments instead of using a single line segment. By using two line segments for each of the suggested paths S13A and S14A, the user of the personal navigation device is still presented with a shorter path through the park 30 than would otherwise be available without using the suggested paths through the park 30. If the personal navigation device is aware of bridges over bodies of water such as a lake, river, or stream, the personal navigation device can also direct the user to the nearest bridge in order to assure a safe passage over the water.

Since the personal navigation device will not be aware of all barriers in all open spaces, users will still have to exercise caution when walking along the suggested paths generated by the personal navigation device. The suggested paths serve as a general guidance for the users, and are not definitive routes that must be adhered to.

In summary, the present invention generates suggested paths across open areas such as parks instead of forcing pedestrians to go around the open areas on a road network. In this way, pedestrians can cut across open spaces in order to reach their destination faster, and can also have a more enjoyable route for walking away from traffic. The ultimate goal is to avoid having to tell the user to travel on the nearest road in situations where traveling through the open spaces results in a faster trip.

Those skilled in the art will readily observe that numerous modifications and alterations of the device and method may be made while retaining the teachings of the invention.

What is claimed is:

1. A method of creating suggested pathways across a predefined area for guiding pedestrians across the predefined area, the method comprising:
loading a polygon representation of the predefined area, the polygon comprising at least four vertices; and
connecting pairs of non-adjacent vertices of the polygon to create the suggested pathways.

2. The method of claim 1 further comprising removing suggested pathways that lie along existing road segments of a road network.

3. The method of claim 1 further comprising displaying suggested pathways on a personal navigation device for guiding a user through the predefined area.

4. The method of claim 1, wherein connecting pairs of non-adjacent vertices of the polygon to create the suggested pathways comprises connecting the non-adjacent vertices directly with a line segment.

5. The method of claim 1 further comprising superimposing boundaries of barriers located in the predefined area onto the polygon representation of the predefined area.

6. The method of claim 5 further comprising altering the suggested pathways to go around the barriers.

7. The method of claim 1 further comprising linking the vertices of the polygon to roads on a road network for guiding users between roads and the suggested pathways.

8. A method of creating suggested pathways across a predefined area for guiding pedestrians across the predefined area, the method comprising:
loading a polygon representation of the predefined area;
identifying all nodes on a border of the polygon, the nodes being formed by the intersection of two roads on or adjacent to the border of the polygon; and
connecting pairs of nodes to create the suggested pathways.

9. The method of claim 8 further comprising displaying suggested pathways on a personal navigation device for guiding a user through the predefined area.

10. The method of claim 8 further comprising removing suggested pathways that lie along existing road segments of a road network.

11. The method of claim 10, wherein connecting pairs of nodes of the polygon to create the suggested pathways comprises connecting the nodes directly with a line segment.

12. The method of claim 8 further comprising superimposing boundaries of barriers located in the predefined area onto the polygon representation of the predefined area.

13. The method of claim 12 further comprising altering the suggested pathways to go around the barriers.

14. A method of creating suggested pathways across a predefined area for guiding pedestrians across the predefined area, the method comprising:
loading a polygon representation of the predefined area, the polygon comprising at least four vertices;
connecting pairs of non-adjacent vertices of the polygon to create suggested pathways;
identifying all nodes on a border of the polygon, the nodes being formed by the intersection of two roads on or adjacent to the border of the polygon; and
connecting pairs of nodes to create suggested pathways.

15. The method of claim 14 further comprising removing suggested pathways that lie along existing road segments of a road network.

16. The method of claim 14 further comprising displaying suggested pathways on a personal navigation device for guiding a user through the predefined area.

17. The method of claim 14, wherein connecting pairs of non-adjacent vertices of the polygon to create the suggested pathways comprises connecting the non-adjacent vertices directly with a line segment, and connecting pairs of nodes of the polygon to create the suggested pathways comprises connecting the nodes directly with a line segment.

18. The method of claim 14 further comprising superimposing boundaries of barriers located in the predefined area onto the polygon representation of the predefined area.

19. The method of claim 18 further comprising altering the suggested pathways to go around the barriers.

20. The method of claim 14 further comprising linking the vertices of the polygon to roads on a road network for guiding users between roads and the suggested pathways.
